(19) United States
(12) Patent Application Publication
(10) Pub. No.: US 2004/0103146 A1
(43) Pub. Date: May 27, 2004

(54) Method and system for physically exercising with plurality of participants using network

(76) Inventor: Seung-Hun Park, Kyoungki-Do (KR)

Correspondence Address: NOTARO AND MICHALOS, 100 DUTCH HILL ROAD, SUITE 110, ORANGEBURG, NY, 10962-2100, US

(21) Appl. No.: 10/304,512

(22) Filed: Nov. 26, 2002

(51) Int. Cl. G06F 15/16; G06F 17/60

(52) U.S. Cl. 709/204; 705/3

(57) ABSTRACT

Disclosed is a method and system for physically exercising with plurality of participants using a network wherein a user can exercise continuously and interestedly without feeling boredom. The system is characterized by comprising: a server which provides a virtual common space for one or more participants to be connected through the network, and makes the participants participate in the virtual common space as virtual objects; and one or more state signal generation apparatus for generating, and providing for the server through the network, one or more state signals including each exercise state signal corresponding to each physical action of the participants so as to control each action of the virtual objects corresponding to each physical action of the participants.

### BACKGROUND OF THE INVENTION

(1) Field of the Invention

The present invention relates in general to a physical exercise system, and in particular to a method and system for physically exercising with plurality of participants using a virtual common space realized through a network such as the Internet, etc.

(2) Description of Related Art

Generally, exercise is short to modern people compared with men of former days. In particular, exercise is absolutely short besides simple and repetitious exercise such as a mouse operation or a keyboard operation. Furthermore, according to the rapid diffusion of the Internet, the time for the modern people to spend before a computer increases. Therefore, interest about health is rising recently compared with in the past.

With such interest, a great number of exercise apparatus were developed, and have been spread. However, the user felt boredom when he used them several times because their action mechanisms are simple, and thus there have been a lot of cases that the exercise apparatus paid for at a high price were not used any more. Devices called DDR have been spread with a burst speed, which connect a computer game and an exercise element in order to supplement such disadvantages. From the fact that DDR has enjoyed large popularity compared with its simple operation, it can be understood that interest has to be accompanied in order to exercise.

However, the former exercise apparatus, which include DDR, have a limit to devices to be used individually. Though the DDR provides a mode for two persons to participate in a game at once, it is not for participant to interact, but it is for individual users to participate in a game in parallel.

Also, former exercise apparatus cause only a physical action of a user, but a health condition of a user cannot be determined nor informed. Or, exercise appropriate to a health condition of a user cannot be prescribed. In view of interest about health of modern people, time for taking diagnosis about a health condition of himself in the hospitals, etc., is short in actuality. Therefore, modern people are hard to know their own health condition. Also, there are a lot of cases to lose health because they cannot receive an appropriate diagnosis about their own health condition at a proper time.

Therefore, development of exercise apparatus, which granted a user a continuous interest, has been requested.

Also, development of exercise apparatus has been requested, which can provide information about physical state of a user during exercise as well as information about a health condition of a user, and which can perform an appropriate diagnosis to a user using such information and information on prescriptions for various diseases.

### BRIEF SUMMARY OF THE INVENTION

Accordingly, the present invention is made in order to solve the above problems, and one object of the present invention is to provide a method and system for physically exercising with plurality of participants using a network wherein a user can exercise continuously and interestedly without feeling boredom.

Further, it is another object of the present invention to provide a method and system for physically exercising with plurality of participants using a network which can measure and reflect an exercise state of a user on a real time action of a virtual object in a corresponding virtual space, and measure a physical state of a user and provide exact information about a health condition of a user.

It is still another object of the present invention to provide a system and method, which can measure a change of a physical state according to an increase or a decrease of exercise, diagnose a health state of a user, and give or renew various kinds of exercise prescriptions suitable for a user.

### DISCLOSURE OF INVENTION

To accomplish the objects of the present invention as a system, a multi-participant physical exercise system is provided in accordance with one embodiment of the invention, which uses a network and an exercise apparatus, said system being characterized by comprising: a server which provides a virtual common space for one or more participants to be connected through the network, and makes the participants participate in the virtual common space as virtual objects; and one or more state signal generation apparatus for generating, and providing for the server through the network, one or more state signals including each exercise state signal corresponding to each physical action of the participants so as to control each action of the virtual objects corresponding to each physical action of the participants.

In this case, said multi-participant physical exercise system may further comprise a virtual object generation means for generating one or more virtual objects in the virtual common space whose actions are controlled by each state signals. Also, said state signal generation apparatus may further comprise: one or more sensing section for sensing a physical action (exercise state) and/or a physical health state of the participant; a processor for receiving a sensing signal of the sensing section and generating state signals indicating the exercise state and/or the health state of the participants; and an interface means for transmitting said state signals to the server through the network.

Furthermore, said virtual common space, which is provided in the server, may comprise a certain exercise competition or a game using a change in each action of the virtual objects. Preferably, said state signals comprise a state signal of a physical health state to be sensed in the state signal generation apparatus, and information on a health state of the participants being analyzed using the state signal of the physical health state in the server and provided from the server. Also, said server preferably comprises a memory means for storing personal information and information on the health state of the participants, and provides information on a history of a health condition of the participants using the information stored on the memory means.

To accomplish the objects of the present invention as a method, a method of physically exercising with plurality of participants, in which a network and an exercise apparatus are used, said method being characterized by comprising the steps of: connecting each of state signal generation apparatus of one or more participants to a server through the network; constructing a virtual common space for a game or an exercise competition in the server and providing the virtual common space in common to each of the participants so as for each of the participants to participate as virtual objects; performing the game or the exercise competition on the basis of the virtual common space; generating in one or more state signal generation apparatus, and providing to the server through the network from the state signal generation apparatus, one or more state signals including each exercise state signal corresponding to each physical action of the participants so as to control each action of the virtual objects corresponding to each physical action of the participants; and controlling each action of the virtual objects so as to fit into the game or the exercise competition under performance in response to the state signals of the participants transmitted to the server.

Preferably, said virtual common space comprises a game space or an exercise competition track, in which a game or an exercise competition is executed, virtual objects, exercise state display parts and real person display parts. Further preferably, said method comprises the step of generating one or more virtual objects so as to show the participants in the virtual common space in the steps of providing with the virtual common space and controlling the virtual objects. Said state signals comprises physical health states of the participants, and said method may further comprise the step of providing with information on at least one of measured physical health information of the participants by the state signals of the exercise state and the physical health state, physical strength and health evaluation information for performing diagnosis after analyzing the physical health information, and exercise prescription information based on the physical health information and the physical strength and health evaluation information.

Also, it is preferable that said method further comprises the steps of analyzing in the server, etc., the state signals on the physical health state fed back biologically during the exercise competition or the game execution, judging whether or not there is any participant inadequate to the exercise competition or the game execution, and taking a measure proper to the inadequate participant.

The present invention and several objects and advantages to be achieved by this invention will become apparent from the following description taken in conjunction with the accompanying drawings wherein certain embodiments of this invention are set forth by way of illustration and example.

### BRIEF DESCRIPTION OF THE SEVERAL VIEWS OF THE DRAWINGS

FIG. 1 illustrates a schematic block diagram of construction for explaining a physical exercise system with plurality of participants using network in accordance with one embodiment of a system of the present invention.

FIG. 2 is a block diagram, in detail, of a state signal generation apparatus in the multi-participant physical exercise system of FIG. 1.

FIG. 3 is a screen configuration diagram showing one example of a virtual common space realized in the multi-participant physical exercise system in accordance to one embodiment of the present invention.

FIG. 4 is a screen configuration diagram showing an example of a display screen after finishing an exercise competition realized in the multi-participant physical exercise system in accordance to one embodiment of the present invention.

FIG. 5 is a flow chart showing a method of physically exercising with plurality of participants using a network, in accordance to one embodiment of the present invention as a method.

### DETAILED DESCRIPTION OF THE INVENTION

Now, a preferred embodiment of the present invention will be described Owith reference to the accompanying drawings for explaining the present invention in detail, wherein like reference numerals depict like elements throughout the several views.

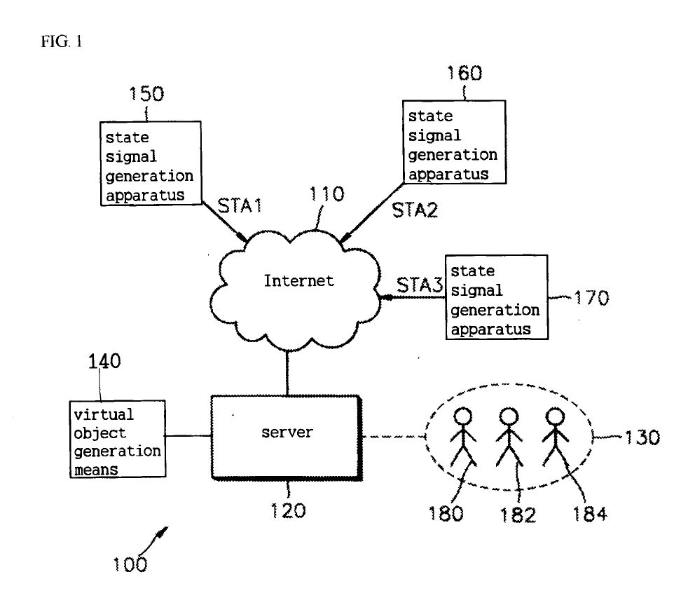

FIG. 1 is a schematic block diagram of construction for explaining a physical exercise system 100 with plurality of participants using a network 110 in accordance with one embodiment of a system of the present invention.

As shown in FIG. 1, the multi-participant physical exercise system 100, in which a server 120 and client systems are connected through the network 110 such as the Internet, etc., comprises multiple state signal generation apparatus 150, 160 and 170. The state signal generation apparatus 150, 160 and 170 generate one or more state signals STA1, STA2 and STA3 corresponding to each physical action (exercise state), or health or physical strength state (physical health state) of the participants, and provide them to the server 120 through the network 110, said state signals STA1, STA2 and STA3 including an exercise state, a health state, a physical strength state, etc. The server 120 provides a virtual common space 130 for one or more participants to be connected through the network 110, and one or more virtual objects 180, 182 and 184 which are generated in the virtual common space 130 and each action of which is controlled by an exercise state among state signals STA1, STA2 and STA3. Furthermore, the server 120 provides predetermined services using a change in each action of the virtual objects 180, 182 and 184 in the virtual common space 130. Also, FIG. 1 shows a system comprising a separate virtual object generation means 140 connected to the server 120, which can be installed in each system of the participants 215. The system can be diversely constructed according to the conventional arts so as to control each action of the virtual objects 180, 182 and 184 corresponding to each physical action or each exercise state of the participants 215 at each moment. For convenience of explanation, three state signal generation apparatus 150, 160 and 170 are shown in FIG. 1, but it is not intended to limit the present invention thereto.

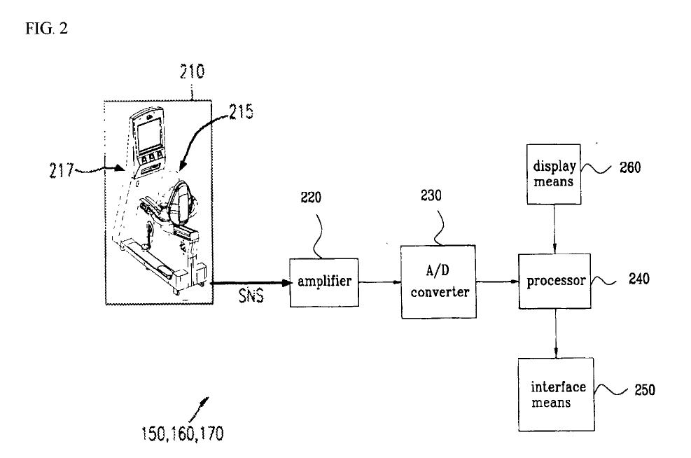

FIG. 2 illustrates in detail an example block diagram of a state signal generation apparatus 150, 160 and 170 in the multi-participant physical exercise system 100 of FIG. 1.

In one embodiment shown in FIG. 2, each of the state signal generation apparatus 150, 160 and 170 comprises one or more sensing section 210, an amplifier 220, an A/D converter 230, a processor 240, an interface means 250, and a display means 260 installed in the exercise apparatus 217. The sensing section 210 senses a physical action of the participants 215. The processor 240 receives sensing signals SNS outputted from the sensing section 210, and generates state signals STA1 indicating an exercise state, a health state, a physical strength state, etc., of the participant. Also, the predetermined interface means 250 provides the generated state signals STA1 to the server 120 via the network 110. And, the display means 260 displays a virtual common space 130. Although it is not shown, it is desirable that a personal information and/or physical health information is stored/renewed in a smart card, read from the smart card and transmitted to the server 120 by comprising a smart card reader/writer.

Referring to FIGS. 1 and 2, the construction of the physical exercise system 100 with plurality of participants using network in accordance with one embodiment of a system of the present invention is explained in detail hereinafter.

First, the sensing section 210 comprises one or more sensors (not shown) installed in the exercise apparatus 217 such as a running machine, etc. The sensors output sensing signals SNS such as exercise extent, weight, electromyogram ((EMG), electroencephalogram (EEG), plethysmogram, etc., of the participant 215. It is desirable that, in order to obtain information on such diverse health states, particularly on heart rate, an electrocardiogram, body fat, etc., sensor with at least three contact points with a body of the participant 215 (three lead type electrocadiograph) is comprised. Since construction and action of such sensors are apparent for those skilled in the art, detailed explanations are omitted from this specifications for a simplification of an explanation. The exercise apparatus 217 having the sensing section 210 may comprise various exercise apparatus such as a running machine, a stepper, a rowing machine, a barbell, a horizontal bar, DDR, etc. For example, a weight scale may be installed in a footboard of the running machine, and a tachometer for measuring moving speed of the footboard may be comprised. A waste calorie of a participant can be easily obtained using a weight and an exercise speed of the participant 215 measured by the weight scale and the tachometer.

Furthermore, the prior art exercise apparatus can be modified and constructed so as to obtain more detailed information on the health state of the participant 215. For example, a sensor (not shown) for sensing arm exercise of the user can be attached to the running machine.

Each sensing signal SNS outputted from the sensing section 210 is amplified through the amplifier 220. The output signal of the amplifier 220 is digitalized by the A/D converter 230. The processor 240 receives and processes the digitalized output, and then generates a state signal STA1 relating to an exercise state, a health state and a physical strength state of the participant 215. The state signal STA1 comprises diverse information on exercise speed or exercise extent of the participant 215 as well as a health and a physical strength of the participant 215 such as electromyogram, electroencephalogram, heart rate, etc. The state signal STA1 generated by the processor 240 is transmitted to the server 120 through the interface means 250 and the network 110 such as the Internet, etc. At this case, a communication means such a web browser, an electronic mail, etc., is comprised for transmitting the state signals STA1 through the Internet. An interface via a modem as well as diverse interfaces such as an xDSL method like an ADSL (Asymmetric Digital Subscriber Line), an advanced ADSL method, a HDSL (High bit rate Digital Subscriber Line) method, etc., an ISDN (Integrated Service Digital Network), etc., can be used as the interface means 250. The server 120 can provide services of a different type according to the network access speed varying with the interface. That is, under high speed interface environment, a virtual common space having more realism can be provided, while it is desirable that a simplified virtual common space is provided considering speed under low speed interface environment.

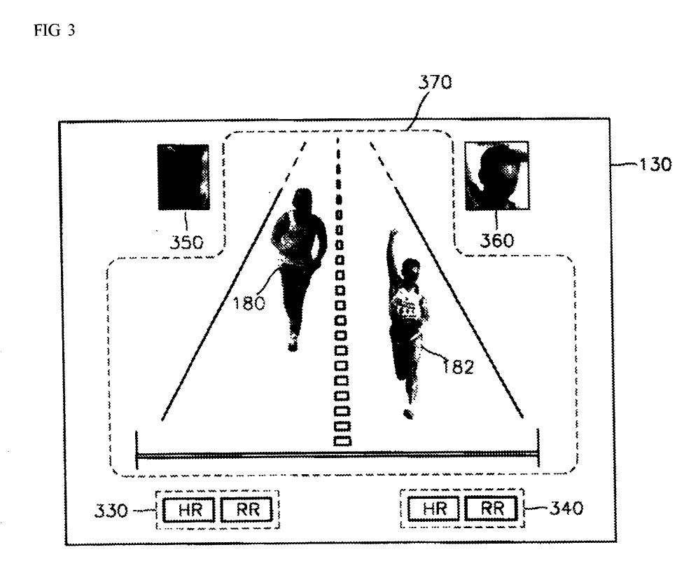

The server 120 provides the virtual common space 130, in which the virtual objects 180, 182 and 184 as a symbol of the participants 215 are generated arbitrarily or optionally after connections of the participants 215, as shown in FIG. 3. The virtual objects 180, 182 and 184 may have any shape capable of inducing interest of the participants 215 such as a person, a character of a famous cartoon film, an interesting animal shape, etc. Each action of the virtual objects 180, 182 and 184 realized in the virtual common space 130 represents each of the participants 215 and is controlled depending on each physical motion (exercise state) of the participants 215. The server 120 outputs the virtual common space 130 to the participants 215 and transmits a display signal for proceeding the exercise competition or the game to the processor 240 via the network 110 and the interface means 250 of the state signal generation apparatus 150, 160 and 170. Then, the processor 240 controls a screen output of the display means 260 according to the display signal. The server 120 provides diverse services using the motion of the virtual objects 180, 182 and 184. The services provided by the server 120 and the virtual common space 130 will be described in more detail in the corresponding part of the present specification.

The state signal generation apparatus 150, 160 and 170 shown in FIG. 2 may comprise a camera and a microphone besides the above-mentioned construction elements, which are not shown herein. The camera and the microphone will be used in taking pictures of the exercise states of the participants and collecting voice signals. The obtained picture information or voice information is amplified through the amplifier 220 and converted through the A/D converter 230, and then transmitted to the processor 240. The processor 240 processes the received signals and generates state signals STA1, STA2 and STA3, and transmits state signals STA1, STA2 and STA3 to the server 120 via the interface means 250 and the Internet, etc. Then, the server 120 can provide various services using the received picture and voice information.

The state signal generation apparatus 150, 160 and 170 shown in FIG. 2 comprises the display means 260, but the display means 260 should not be comprised by the state signal generation apparatus 150, 160 and 170. The display means 260 may be connected directly to the network 110 such as the Internet, etc., separately from the state signal generation apparatus 150, 160 and 170. But, there is a difference that, when the display means 260 is separately connected to the network such as the Internet, the received signal is directly outputted, while the signal provided from the server 120 can be separately processed in the processor 240 when the display means 260 is connected to the processor 240.

The server 120 may further comprise a database (not shown), which comprises personal information of the participants, results of exercise or a game, a health state and a physical strength state of the participants 215 during exercise and their changes, etc. Then, the server 120 may diagnose disease in an early stage using the database and measuring a health and a physical strength of the participant 215, and grasp a change in the physical state of the participant. Then, when there is an abnormal change in the physical state of the participant, the server 120 can detect it early, which will be described in more detail in the following.

When the participant 215 is connected to the server 120, the personal information of the participant 215 is read out. Of course, when the participant 215 is connected at the first time, he inputs his personal information. The inputted personal information is written in the database and systematically administered. When the participant 215 inputs his personal information (for example, height, weight, disease history, mature disease, age, etc.,), there is also a case that the health state of the participants 215 can be judged on the basis of the inputted personal information. For example, although the participants 215 ran the same distance for the same time, the health states of the participants 215 are decided on the basis of the personal information of the participants 215. That is, a health state of the participant of his fifties in age, who ran the distance of 1000m for 10 minutes, can be judged to be better than the participant 215 of his twenties in age who ran the same distance for the same time.

Furthermore, the server 120 can diagnose whether to have a disease at an early stage by using information stored in the database. For example, the early diagnosis about whether the participant suffers from false heart disease can be performed by measuring heart rate of the participant after running a certain distance. During such early diagnosis process, the personal information and the health strength information stored in the database are used. And, the server 120 can detect a change into an abnormal state in the body state of the participant during exercise of the participant. For example, an abnormal increase in heart rate or the beating of the pulse, etc., as compared with in the past exercise, can easily detected by using the information stored in the database. When such an abnormal change in the body state, the server 120 can warn the participant of it, and therefore, occurrence of a sudden accident can be prevented.

FIG. 3 is a screen configuration diagram showing one example of the virtual common space 130 realized in the multi-participant physical exercise system in accordance to one embodiment of the present invention. The virtual common space 130 shown in FIG. 3 is a running race track using a first and a second virtual objects 180 and 182. In FIG. 3, the virtual common space 130 comprises the running race track 370, the virtual objects 180 and 182, a first and a second exercise state display parts 330 and 340 and a first and a second real person display parts 350 and 360.

The motions in the first and the second virtual objects 180, 182 and 184 are controlled by the first and the second state signals STA1 and STA2 (shown in FIG. 1). The server 120 makes two participants perform a running race game. For this performing, the running race track 370 is arranged in the virtual common space 130, and the first and the second virtual objects 180 and 182 line up for the start. The server 120 provides diverse tracks such as 100m, 400m, 1,000m, etc., among which the participants can select a running event. Real appearances of the first and the second participants can be shown in the first and the second real person display parts 350 and 360. Therefore, the participants can confirm the other party^{▪}real appearance through the real person display parts 350 and 360 by receiving an picture signal transmitted by means of a picture transmission device (not shown) of each sensing section 210, and have a chat with each other with looking at a screen by transmitting a voice signal to the server via a separate device (not shown).

In the real person display parts 350 and 360, the appearances of the real participants need not appear, and a certain object (for example, a picture, an advertisement, a moving picture, etc.) capable of inducing interest of the participants can appear.

When a match starts, the participants start exercise. Information on an exercise state according to exercise speed or exercise extent and a physical strength and health state of the participants is collected by diverse sensors (not shown) included in the sensing section 210 shown in FIG. 2, and is provided to the server 120 via the foregoing processes. The server 120 displays the information on the exercise state and a physical strength and health state of the participants in the first and the second exercise state display parts 330 and 340. In the embodiment shown in FIG. 3, heart rate HR, respiration rate RR, and the like are provided as the exercise states and the physical strength states of the participants in the exercise state display parts 330 and 340. The same effect as in a real running race can be obtained by using physical data such as heart rate, respiration rate, exerce speed and waste calorie of the participants and making the moving speed of the virtual objects 180 and 182 different. Furthermore, the server 120 can manage a match most interestingly by outputting an effect sound for cheering the first or the second virtual object 180 or 182 while the match proceeds. When one (for example, the first virtual objects 182) of the virtual objects 180 and 182 passes through the finish line first, the server 120 sounds a fanfare for the first participant and outputs a message for urging efforts to the second participant, thereby being able to increase interest of the match.

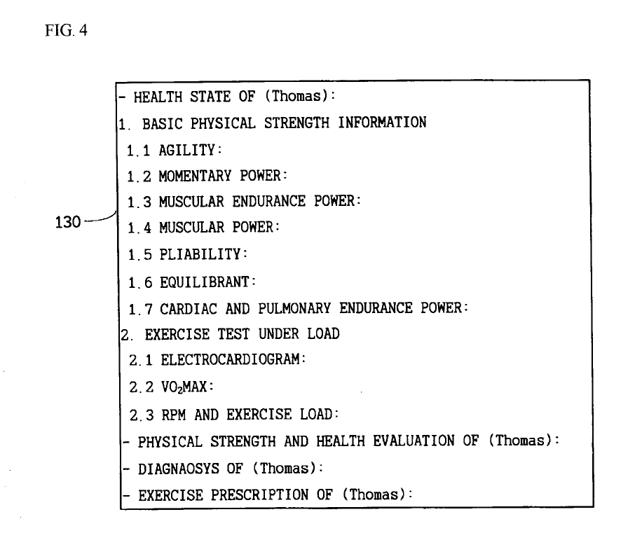

When the match is finished, the server provides in detail the health information of each participant using information on the exercise states of the participants. One example of the health information of the participant displayed on the screen instead of the virtual common space 130 is illustrated in FIG. 4.

As known from FIG. 4, which is a screen configuration diagram showing an example of a display screen after finishing the exercise competition realized in the multi-participant physical exercise system in accordance to one embodiment of the present invention, the server 120 provides various basic physical strength information such as agility, momentary power, muscular endurance power, muscular power, pliability, equilibrant, cardiac and pulmonary endurance power, etc., and information on physical strength during exercise such as electrocardiogram, maximum oxygen intake (VO2max), etc., as the health state of the participant. Then, such information is synthesized and overall health state is diagnosed. The exercise extent, weight, electromyogram, electroencephalogram, plethysmogram, heart rate and its change, body fat, blood pressure, etc., of the participant can also be presented. As the server 120 provides the health state information shown in FIG. 4, the participants 215 can exercise through an interesting exercise competition or game without feeling boredom, and obtain his synthetic diagnosis on his own health after finishing exercising. Preferably, information on history of the health states of the participants is stored in a database (not shown) arranged in the server 120. In order to perform such action, the server 120 can receive a user's affiliation subscription and perform continuous diagnosis and effective health administration on the user's health, thereby being able to function as a synthetic health portal web site.

More desirably, the server 120 establishes comprehensive database of all kinds of diseases and prescription about each disease, and provides a most appropriate exercise prescription on the basis of the established database. Exercise prescription is to prevent diseases in advance which can occur in future, and to take action on occurred diseases so as to be healed early by providing with the most appropriate exercise information as for a health state of a participant (proper kind of exercise, proper extent of exercise, proper exercise time, etc.,). In order to give desirable exercise prescription, the server 120 may provide information on a health state of the participant to special medical organizations such as hospitals, or exercise facilityies such as health clubs, thereby capable of obtaining more special consultation.

The example of the virtual common space 130 offered in FIG. 3 is given as for a running race in which two participants 215 participate, as one service provided by the server 120, and is not intended to limit the technical principle of the present invention. It is possible to provide with a service of a certain kind or type which can give continuous interest to the participant by making the participant do a certain physical motion and displaying the physical motion of the participant by means of corresponding movement of the virtual objects 180 and 182 on the virtual common space 130.

Furthermore, the number of the participant 215, whom the server 120 provides the service to, did not necessarily have to be a plurality who do interaction with each other. Even a single user can take interesting exercise using diverse kinds of services such as a hiking, climbing, etc. For example, the server 120 can realize a climbing path or course for the single user on the virtual common space 130. Then, the single user can take exercise using an exercise apparatus such as a cycle, with looking at climbing or hiking action of the virtual object reflecting himself. The server 120 can realize the variable climbing or hiking path in order to induce continuous concern and interest of the participant and can provide various sound effects. It is possible to make a reference person participate in a game or an exercise competition and play the game or the exercise competition with the reference person. It is desirable that the server 120 provides various reference persons who have various levels of physical strength so as to select one similar to himself. Also, the participant can take continuous exercise without losing interest on the virtual common space 130 which the server 120 provides. When tired, he can have a rest or finish the exercise in the middle. When the user has finished the game or exercise, the server 120 can provide information on the user's exercise intent and health state as shown in FIG. 4.

With other example, the participant can exercise in an apparatus similar to DDR, and the server can realize a service in which the participant's exercise is sensed, and his momentary power is measured and provided.

Furthermore, screen construction of the virtual common space 130 shown in FIG. 3, is not limitative. Rather, any screen construction can be operative if the motion of the virtual objects 180 and 182 can be controlled and represented according to the physical exercise of the participants 215. Preferably, the virtual common space 130 according to the present invention is three-dimensional virtual common space as shown in FIG. 3, for it can provide more reality to the participants. The participants will feel real ambience as they participate directly in the virtual common space through the virtual objects of themselves moving in the virtual common space. The first and the second real person display parts 350 and 360 shown in FIG. 3 are provided in order to increase interest by confirming each appearance of the interactive participants directly. It is desirable that the real person pictures to be displayed in the real person display parts 350 and 360 are transmitted using MPEG-4 compression technology for high speed motion. In addition, the interaction of the participants may be planned to occur more realistically by realizing sound signals of the participants or messages inputted by the participants on the real person display parts besides the real person pictures.

Additionally, it is more preferred that full immersion virtual reality is provided by comprising devices (not shown) for sensing in detail the participant's action in state signal generation apparatus 150, 160 and 170 of the multi-participant physical exercise system 100 according to the present invention. For realizing full immersion virtual reality, the state signal generation apparatus 150, 160 and 170 shown in FIG. 2 may comprise additional devices like a three-dimensional audio device, a space tracking device and a data glove.

However, the virtual common space 130 according to the present invention is not limited to the three-dimensional space. Rather, by sharing a two-dimensional virtual common space, it is advantageous that the virtual objects can move faster. Also, the virtual common space should not absolutely comprise the virtual objects as an element, but information can be represented by a simple numerical representation or graph for a fast action speed.

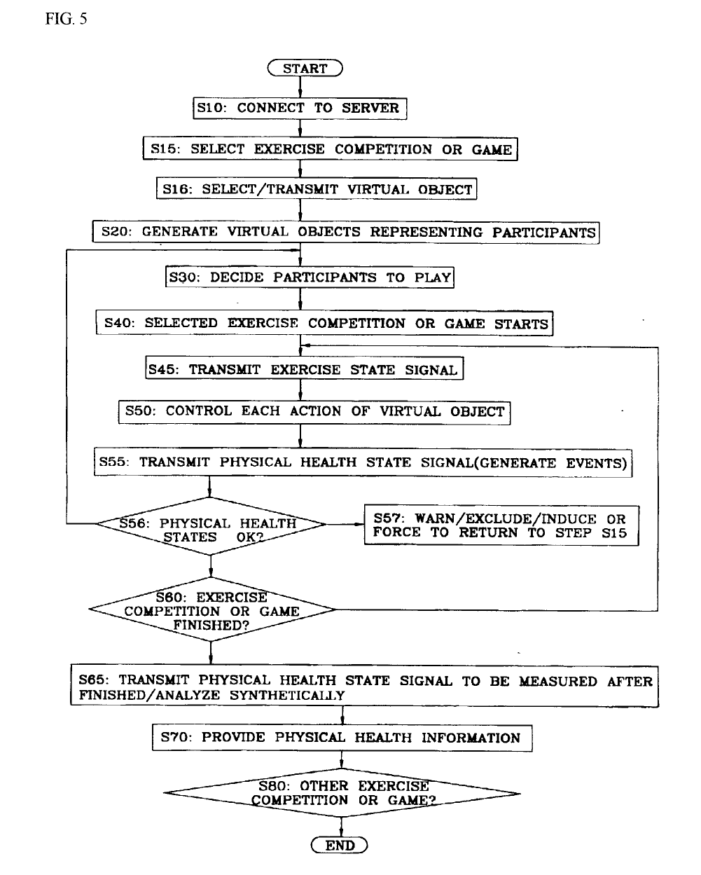

FIG. 5 is a flow chart showing a method of physically exercising with plurality of participants using a network, in accordance to one embodiment of the present invention as a method. The method of exercising of multiple participants using a network according to the present invention comprises the following steps.

First, the participant 215 connects his state signal generation apparatus to the server 120 via a network 110. If necessary, the step for logging in or registering (new subscription), or the step of inputting/renewing can be given. Although not shown, in case of comprising a smart card reader/writer, it is possible to store the person information and/or the physical health state in the smart card, and to read/transmit the information from the smart card to the server 120. The participant 215 connected to the server 120 may be a single or a plurality. At this time, the step of selecting an exercise competition or a game (step S15) may be comprised, or if necessary, the step of setting an environment for the exercise competition or the game.

Subsequently, the server 120 generates virtual objects for representing the participants (step S20). The virtual objects 180, 182 and 184 can be generated by being established by means of the server 120, etc., arbitrarily or in a predetermined method, or in step S16 the participants 215 can select or input and transmit his desirable virtual objects 180, 182 and 184.

The participants 215 can participate in various services (a game or an exercise competition) provided by the server 120 by means of the established, selected or inputted/transmitted virtual objects 180, 182 and 184. The server 120 decides the participants 215 to play the exercise competition or the game together when a plurality of the participants select and register for services in which a plurality of the participants can participate (step S30). At this time, the decision of the participants 215 can be made by amounting to the predetermined number of the participants and/or by determining the participants 215 to play among the registered participants after a certain time.

Thus, when the participants are determined, the exercise competition or the game starts (step S40). The steps S16 and S20 are preferably executed after deciding the participants to play before the exercise competition or the game starts. When the exercise competition or the game starts, the server 120 receives state signals STA1, STA2 and STA3 on each exercise state corresponding to each physical action of the participants 215 from the state signal generation apparatus 150, 160 and 170 (step S45), and then controls each action of the virtual objects 180, 182 and 184 corresponding to each physical action of the participants 215 (step S50). Execution of the exercise competition or the game can be displayed through each display means 260 of the participants 215 by transmitting display data including the virtual objects 180, 182 and 184. In this case, in step S50, picture display data, in which the virtual objects 180, 182 and 184 are controlled and composed, are transmitted from the server 120. Alternatively, the server 120 may transmit only control commands and the virtual objects 180, 182 and 184 in the exercise competition or the game can be controlled and composed or modified using the control commands.

The exercise competition or the-game can be executed by the processor 240 of the state signal generation apparatus 150, 160 and 170 or by separate processor, etc., using a memory means of the state signal generation apparatus 150, 160 and 170. In this case, the server 120 can transmit control commands for synchronizing each exercise competition or game executed in each system of the participants 215 and control commands for controlling the virtual objects 180, 182 and 184 in step S50.

In step S55, in order to analyze and evaluate the participant's physical strength and health, and in order to give exercise prescription information, physical strength and health information is measured in the sensing section 210, and sensing signals SNS sensed in the sensing section 210 are transmitted from the state signal generation apparatus 150, 160 and 170 to the server 120. If necessary, that is, if the participants 215 have to do a certain behavior for measuring certain information, an event such as an abrupt situation, a text, sound, voice, etc., is displayed on a screen or conveyed via speakers during the exercise competition or the game so as for the participants to duly recognize, and prepare for, measurement. After a certain time for preparing for measurement, physical strength and health information can be measured in the sensing section 210, and sensing signals SNS sensed in the sensing section 210 can be transmitted from the state signal generation apparatus 150, 160 and 170.

The sensing signals SNS can be used for bio-feedback during the exercise competition or the game, thereby being able to inform, for example, whether or not the participant is proper to the exercise competition or the game. In step S56 for such bio-feedback, whether or not the participants 215 are proper is judged using the server 120, etc., after analyzing the state signals STA1, STA2 and STA3 on physical strength and health state during the exercise competition or the game. If there is any improper participant, he is warned/excluded and then can be induced or forced to return to step S15 in order to remove him from dangerous situations of the exercise competition or the game and so as for him to be able to select other level of an exercise competition or a game (step S57).

Then, the server 120 determined whether the exercise competition or the game is finished or not (step S60). If the exercise competition or the game is not finished, the above steps after step S40 are repeated with continuous execution of the exercise competition or the game. If the exercise competition or the game is finished, the step may be comprised, in which physical strength and health information to be measured after the game execution, is measured, if necessary, with generating corresponding events after the game execution, and measured state signals STA1, STA2 and STA3 are transmitted (step S65). Also, the step of analyzing each physical strength and health state of the participants 215 synthetically can be comprised.

Subsequently, the server 120 provides information on the obtained physical strength and health state of the participant in step S70, preferably with information on evaluation of the physical strength and health and exercise prescription. In this case, although not specifically illustrated in the drawings, preferably, the state signal generation apparatus 150, 160 and 170 may comprise a smart card reader/writer and the method according to the present invention may also comprise the step of storing/renewing personal information and/or physical strength and health information in the smart card.

Then, it is confirmed whether or not the participants 215 can play any further exercise competition or the game (step S80). If the participant 215 wishes to play the same or other exercise competition or the game, the game is continued to repeat steps from step S30 for deciding participants to play the same exercise competition or the game together.

As described above referring to FIG. 5, only one example among services which the server 120 can provide, is illustrated and explained as the method of physically exercising with plurality of participants using a network. The flowchart shown in FIG. 5 can be modified depending on a kind or character of a service which the server 120 provides. For example, in case where the server 120 provides a service for a single participant, the step for deciding participants to play the same exercise competition or the game together (step S30) is not required.

Further, the method of physically exercising with plurality of participants using a network in accordance with one embodiment of the present invention can preferably comprise the step of giving most appropriate exercise prescription for the participant using the information on the physical health state of the participant. Also, it is desirable that the method may comprise the step of providing information on the health state of the participant to special medical organizations such as hospitals, or exercise facilities such as health clubs, thereby capable of obtaining more special consultation.

Although the present invention has been described in detail with respect to preferred embodiments thereof, it will be apparent for those skilled in the art that the descriptions are nothing but examples, and various modifications, improvements or applications are possible with respect to the shown embodiment within the scope of the present invention. For example, the Internet is exemplified for the network 110 in the present invention, which is not intended to limit the practice of the present invention. Instead, the network may also be replaced with a local area network (LAN), etc., for inducing mutiple participants. Accordingly, the true technical scope for protecting the present invention should be defined in the following claims.

According to the configuration and acting of the method of, and the system for, physically exercising with plurality of participants using a network in accordance with the embodiments of the present invention described above, the participants can exercise continuously and interestedly without feeling boredom. And, the participants can obtain exact information on each physical health state of themselves and an exercise prescription proper to each physical health state according to the present invention.

1. A multi-participant physical exercise system which uses a network and an exercise apparatus, said system being characterized by comprising:
a server which provides a virtual common space for one or more participants to be connected through the network, and makes the participants participate in the virtual common space as virtual objects; and
one or more state signal generation apparatus for generating, and providing for the server through the network, one or more state signals including each exercise state signal corresponding to each physical action of the participants so as to control each action of the virtual objects, corresponding to each physical action of the participants.

2. A multi-participant physical exercise system according to claim 1, said multi-participant physical exercise system further comprising a virtual object generation means for generating one or more virtual objects in the virtual common space whose actions are controlled by each state signals.

3. A multi-participant physical exercise system according to claim 1, said state signal generation apparatus, further comprising:
one or more sensing section for sensing a physical action (exercise state) and/or a physical health state of the participant;
a processor for receiving a sensing signal SNS of the sensing section and generating state signals indicating the exercise state and/or the health state of the participants; and
an interface means for transmitting said state signals to the server through the network.

4. A multi-participant physical exercise system according to claim 1, said virtual common space, which is provided in the server, comprising a certain exercise competition using a change in each action of the virtual objects.

5. A multi-participant physical exercise system according to claim 1, said virtual common space, which is provided in the server, comprising a certain game using a change in each action of the virtual objects.

6. A multi-participant physical exercise system according to claim 1, said state signals comprising a state signal of a physical health state to be sensed in the state signal generation apparatus, and information on a health state of the participants being analyzed using the state signal of the physical health state in the server and provided from the server.

7. A multi-participant physical exercise system according to claim 1, said server comprising a memory means for storing personal information and information on the health state of the participants, and providing information on a history of a health condition of the participants using the information stored on the memory means.

8. A multi-participant physical exercise system according to claim 7, the memory means further comprising a smart card.

9. A method of physically exercising with plurality of participants using a network and an exercise apparatus, said method being characterized by comprising the steps of:
connecting each of state signal generation apparatus of one or more participants to a server through the network;
constructing a virtual common space for a game or an exercise competition in the server and providing the virtual common space in common to each of the participants so as for each of the participants to participate as virtual objects;
performing the game or the exercise competition on the basis of the virtual common space;
generating in one or more state signal generation apparatus and providing to the server through the network from the state signal generation apparatus, one or more state signals including each exercise state signal corresponding to each physical action of the participants so as to control each action of the virtual objects corresponding to each physical action of the participants; and
controlling each action of the virtual objects so as to fit into the game or the exercise competition under performance in response to the state signals of the participants transmitted to the server.

10. A method of physically exercising with plurality of participants using a network according to claim 9, said method further comprising the step of generating one or more virtual objects so as to show the participants in the virtual common space in the steps of providing with the virtual common space and controlling the virtual objects.

11. A method of physically exercising with plurality of participants using a network according to claim 9, said virtual common space comprising a game space or an exercise competition track in which a game or an exercise competition is executed, virtual objects, exercise state display parts and real person display parts.

12. A method of physically exercising with plurality of participants using a network according to claim 9, said state signals comprising physical health states of the participants, and said method further comprising the step of providing with information on at least one of measured physical health information of the participants by the state signals of the exercise state and the physical health state, physical strength and health evaluation information for performing diagnosis after analyzing the physical health information, and exercise prescription information based on the physical health information and the physical strength and health evaluation information.

13. A method of physically exercising with plurality of participants using a network according to claim 9, said method further comprising at least one of the steps of:
affiliating and registering as a member for connecting to the server or logging on the network;
reading from, or storing to, memory means such as a smart card, a hard disk, etc., personal information and/or physical strength and health information; and
selecting one of games and exercise competitions providing a virtual common space.

14. A method of physically exercising with plurality of participants using a network according to claim 9, said method further comprising one of the steps of transmitting an virtual objects directly from the participants to the server, and selecting one among virtual objects provided from the server.

15. A method of physically exercising with plurality of participants using a network according to claim 9, said method further comprising the steps of analyzing in the server etc., the state signals on the physical health state fed back biologically during the exercise competition or the game execution, judging whether or not there is any participant inadequate to the exercise competition or the game execution, and taking a measure proper to the inadequate participant.
